(19) United States
(12) Patent Application Publication
(10) Pub. No.: US 2022/0018669 A1
(43) Pub. Date: Jan. 20, 2022

(54) A METHOD FOR SEARCHING THE SHORTEST PATH OF MUST-PASS NODES

(71) Applicant: Guangxi Hualan Geotechnical Engineering Co., Ltd., Nanning, Guangxi (CN)

(72) Inventors: Yunan Lu, Nanning, Guangxi (CN); Jinzhan Wei, Nanning, Guangxi (CN); Zhaomin Zhu, Nanning, Guangxi (CN); Ning Wu, Nanning, Guangxi (CN); Weirong Qin, Nanning, Guangxi (CN); Weichun Lu, Nanning, Guangxi (CN); Minghui Chen, Nanning, Guangxi (CN); Yuan Tang, Nanning, Guangxi (CN)

(21) Appl. No.: 17/284,777

(22) PCT Filed: Oct. 9, 2020
(86) PCT No.: PCT/CN2020/119986

§ 371 Date: Apr. 12, 2021

(30) Foreign Application Priority Data
Nov. 18, 2019 (CN) 201911129998.4

(51) Int. Cl. G01C 21/34

(52) U.S. Cl. CPC G01C 21/3446

(57) ABSTRACT

The present disclosure discloses a method for searching the shortest path of must-pass node, which includes the following processing steps: S1, constructing a Thiessen polygon; S2, when start node of must-pass nodes and end node of must-pass node are not the same must-pass node, performing processing of S3; S3, starting from the Thiessen polygon where the start node of must-pass nodes is located, querying the adjacent Thiessen polygons and merging them into the first merged polygon; S4, based on the first merged polygon, querying the unprocessed adjacent Thiessen polygons to merge the second merged polygon; S5, merging the isolated Thiessen polygon into a certain adjacent merged polygon with common edge; S6, deleting the edge lines of two vertices in Denaulay triangle that are not in the same merged polygon; S7. if the node degree of the remaining edge lines in the merged polygon is not greater than or equal to three, then proceed to S8; S8, connecting the edge lines of each merged polygon end-to-end, and the shortest connection line is the result. The present disclosure can effectively reduce the processing difficulty, cost and time, and improve the search efficiency.

### CROSS REFERENCE TO RELATED DISCLOSURE

This disclosure claims priority benefit of Chinese Patent disclosure No. CN201911129998.4, filed on Nov. 18, 2019, and the entire contents of which are incorporated herein by reference.

### TECHNICAL FIELD

The present disclosure relates to the field of computer graphics and geographic information science, and particularly relates to a method for searching the shortest path of must-pass nodes.

### BACKGROUND

The shortest path search method under the must-pass nodes is a research hotspot of mathematics and computer graphics, and it has great application potential in the fields of logistics, resource allocation, and military. However, the traditional shortest path search methods under the must-pass nodes are mostly carried out from the perspective of graph theory and mathematics, and the search efficiency and accuracy are not satisfactory, and the geographic information of the spatial location is ignored. In addition, when the sample data complexity come to a certain level, the shortest path search method under the must-pass nodes is difficult to figure out under computers and traditional algorithms.

The shortest path search method under the must-pass nodes belongs to the path search problem of the must-pass nodes under the obstacle environment, so the traditional path search method is suitable for the shortest path search field under the must-pass nodes. However, in view of the particularity of the shortest path search method under the must-pass node, the sequential optimization combination and the geographical location information of the must-pass nodes have not been considered much, therefore, no scholars in the research apply the traditional path search method to the shortest path search field under the must-pass nodes to reduce the difficulty, cost and time of processing.

### SUMMARY

The objective of the present disclosure is to provide a method for searching the shortest path of must-pass nodes, which is efficient and stable, can effectively reduce the difficulty, cost and time of processing, and improve the searching efficiency.

In order to achieve the objective, the present disclosure provides a method for searching the shortest path of must-pass nodes. The method includes the following processing steps:

S1. acquiring must-pass nodes and constructing Thiessen polygons according to the must-pass nodes;

S2. determining whether a start node of the must-pass nodes and an end node of the must-pass nodes are the same must-pass node, if not, performing S3 processing directly;

S3. starting from a Thiessen polygon where the start node of the must-pass nodes is located, querying Thiessen polygons adjacent to the Thiessen polygon; then merging the adjacent Thiessen polygons in the Thiessen polygons adjacent to the Thiessen polygon in sequence into the first merged polygon, and then performing S4 processing; if there is a non-adjacent and isolated Thiessen polygon among the queried adjacent Thiessen polygons, performing S5 processing on the non-adjacent and isolated Thiessen polygon correspondingly;

S4. querying unprocessed Thiessen polygons adjacent to the first merged polygon based on the first merged polygon, and then merging adjacent unprocessed Thiessen polygons in the unprocessed Thiessen polygons adjacent to the first merged polygon in sequence into the second merged polygon; if there is a non-adjacent and isolated unprocessed Thiessen polygon in the adjacent unprocessed Thiessen polygons, performing S5 processing on the non-adjacent and isolated Thiessen polygon correspondingly, until all Thiessen polygons are processed.

S5. if there is a non-adjacent isolated Thiessen polygon in the Thiessen polygons adjacent to the Thiessen polygon where the start node of the must-pass nodes is located, or in the adjacent unprocessed Thiessen polygons of a certain merged polygon, merging the isolated Thiessen polygon with a certain merged polygon with an adjacent common edge, so as to ensure that there are only two adjacent merged polygons in each merged polygon, except the Thiessen polygon where the start node of the must-pass nodes is located and the Thiessen polygon where the end node of the must-pass nodes is located;

S6. establishing the Denaulay triangle by every must-pass node, and deleting edge lines of two vertices in Denaulay triangle that are not in the same merged polygon;

S7. if a node degree of remaining edge lines in the merged polygon is not greater than or equal to three, then performing S8, otherwise selecting the shorter edge line according to a principle of closing both sides of graph;

S8. connecting the edge lines of each merged polygon end-to-end, and the shortest connection line is a result.

Preferably, in S2, if the start node of the must-pass nodes and the end node of the must-pass nodes as the same must-pass node, this return type is taken as a return mode, all the must-pass nodes are divided into two parts by a boundary line between the must-pass node and a must-pass node with the farthest distance to the must-pass node, and then performing S3 processing on the two parts respectively.

Preferably, in S8, when the edge lines of each merged polygon are connected end-to-end, if the edge lines are self-intersecting, the merged polygons where the self-intersecting lines are located is merged again, and then performing S6 to S8 again.

Preferably, the steps of selecting shorter edge line according to the principle of closing both sides of the graph in S7 are as follows:

S71. if there is a triangle, then removing the longest edge line; after removing the longest edge line, if the graph is still closed, removing the longest edge line in the closed graph again;

S72. if there is no triangle, selecting the Denaulay triangle around a must-pass node with a node degree greater than three, and returning to S71 again for processing to ensure that there is no must-pass node with the node degree greater than or equal to three.

Preferably, the search method is used for plane solution.

Compared with the prior art, the present disclosure has the following advantageous effects:

In the present disclosure, the Thiessen polygons and Denaulay triangles are established based on the must-pass nodes to perform route search, which is efficient and stable, can effectively reduce the difficulty, cost and time of processing, and improve the search efficiency.

Dimensionality promotion represents infinite possibilities, and dimensionality reduction represents simplified solution of the problem. The difficulty of the point-to-point connection problem is that the divergence space of the solution is multi-dimensional (two-dimensional), which is not an extension of traditional logical thinking. Therefore, it is difficult to solve multi-dimensional problems without the help of multi-dimensional thinking. The point connection problem proposed by the present disclosure extends to lines, and the line problem extends to surfaces. The connectivity of the line is analyzed through the surface, and the local optimization of the point connection is ensured by the line. This is a concrete realization of the direct dimensionality promotion solution of the point-to-point connection problem. The method of the present disclosure is a brand-new solution to the traveler problem. It is the first time that mathematical logic problems are solved through spatial information science and technology. It has important academic value and practical significance, and has huge application potential in both civilian and military fields.

### BRIEF DESCRIPTION OF THE DRAWINGS

FIG. 1 is a structural block diagram of the present disclosure;

FIG. 2 is a schematic diagram of the structure of Thiessen polygons established with must-pass nodes in the first embodiment;

FIG. 3 is a schematic diagram of the structure of a merged polygons formed after merging in the first embodiment;

FIG. 4 is a schematic diagram of the Denaulay triangle structure established by the must-pass nodes in the first embodiment;

FIG. 5 is a structural diagram of the structure after the parts where the node degree is greater than three is removed in the first embodiment;

FIG. 6 is a schematic diagram of the connection structure of the must-pass nodes in the merged polygon in the first embodiment;

FIG. 7 is a schematic diagram of the overall connection structure of the must-pass nodes in the first embodiment;

FIG. 8 is a schematic diagram of the structure of the Thiessen polygons established by the must-pass nodes in the second embodiment;

FIG. 9 is a schematic diagram of the structure of a merged polygon formed after merging in the second embodiment;

FIG. 10 is a schematic diagram of the Denaulay triangle structure established by the must-pass nodes in the second embodiment;

FIG. 11 is a schematic diagram of the connection structure of the must-pass nodes in the merged polygon in the second embodiment;

FIG. 12 is a schematic diagram of the first structure after the parts where the node degree is greater than three is removed in the second embodiment;

FIG. 13 is a schematic diagram of the second structure after the parts where the node degree is greater than three is removed in the second embodiment;

FIG. 14 is a schematic diagram of the third structure after the parts where the node degree is greater than three is removed in the second embodiment;

FIG. 15 is a schematic diagram of the overall connection structure of the must-pass nodes in the second embodiment.

### DETAILED DESCRIPTION OF THE EMBODIMENTS

The technical solution of the present disclosure is further described in detail in combination with the drawings, but the protection scope of the disclosure is not limited to the following embodiments.

### Embodiment 1

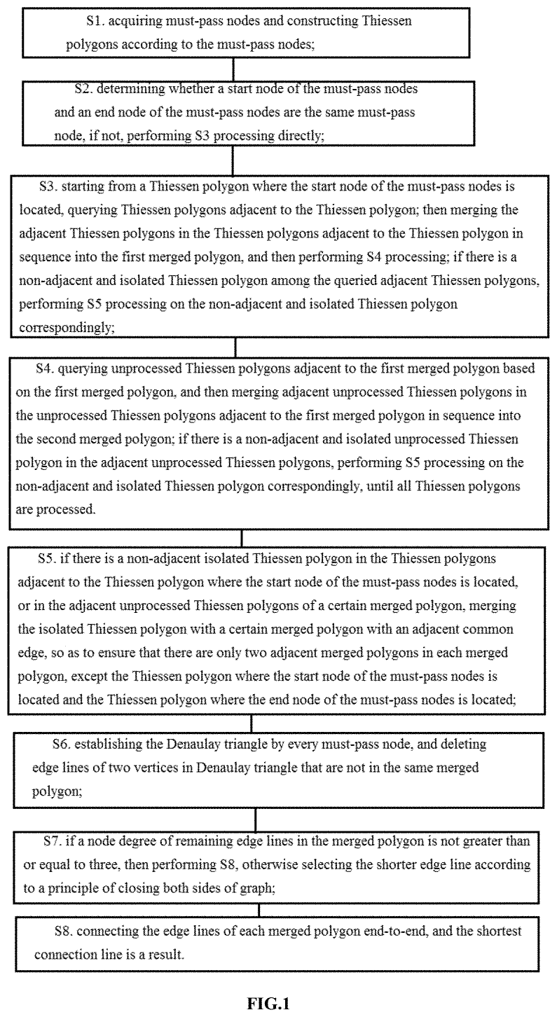

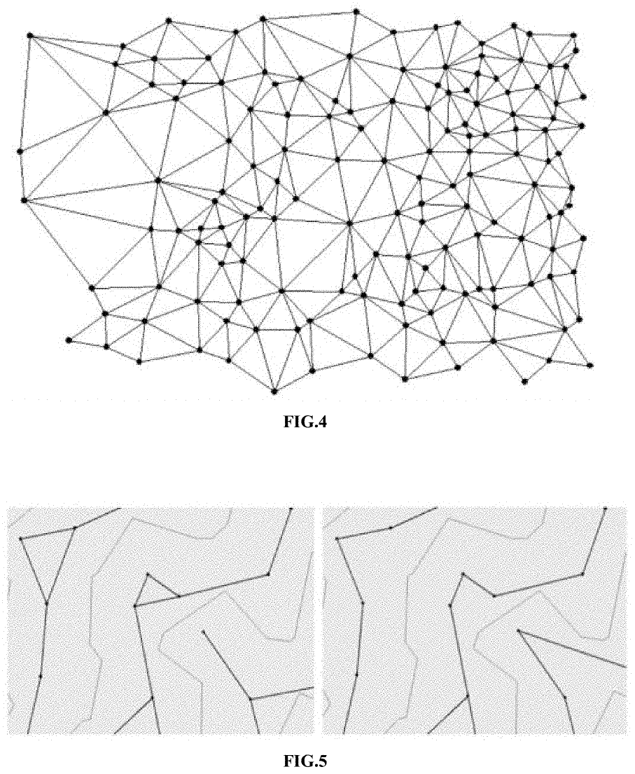

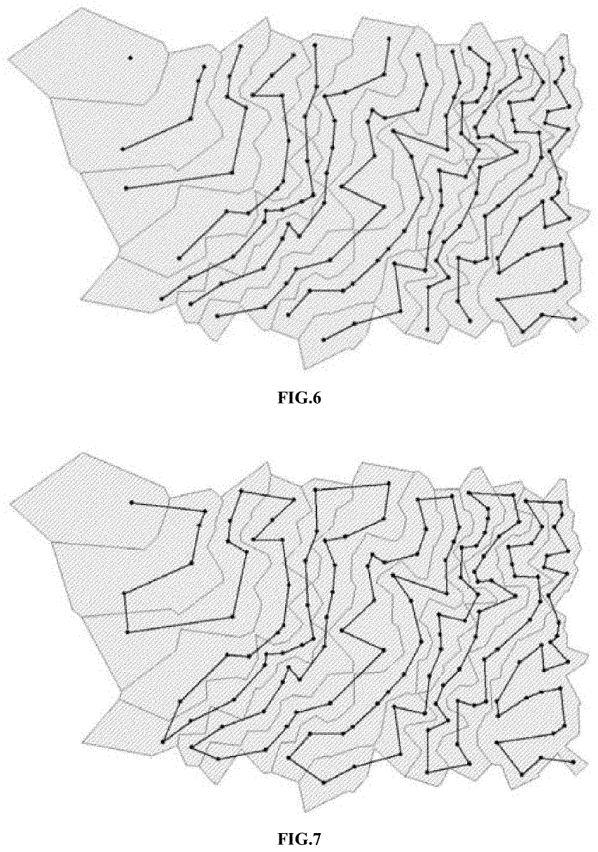

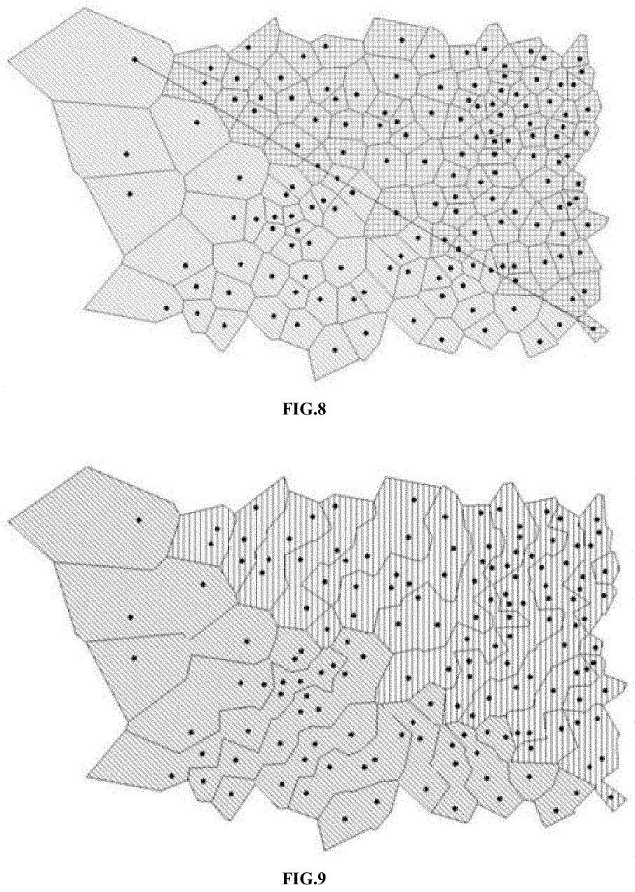

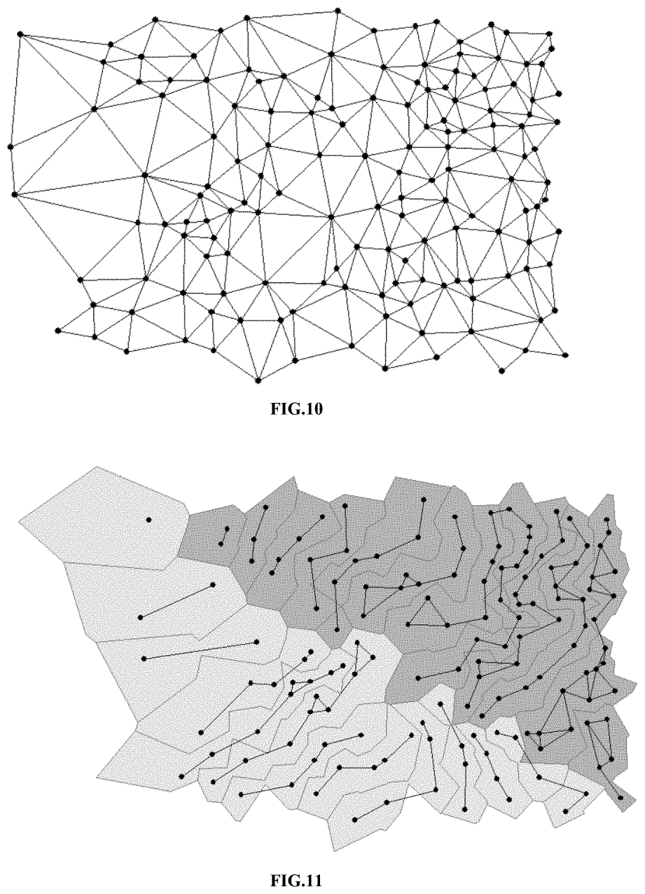

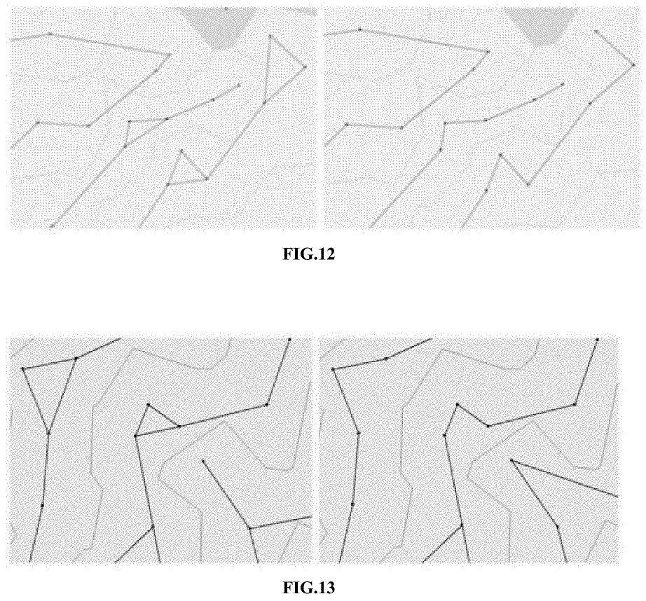

As shown in FIG. 1 to FIG. 7, the present disclosure provides a search method for the shortest path of nodes that must pass through, which is realized through the path midline and spatial topological relationship, and the search method is used for plane solving;

The method includes the following processing steps:

S1. acquiring must-pass nodes and constructing the Thiessen polygons according to the must-pass nodes;

S2. determining whether the start node of the must-pass nodes and the end node of the must-pass nodes are the same node that must pass, if not, proceed to S3 directly;

S3. Starting from a Thiessen polygon where the start node of the must-pass nodes is located, querying Thiessen polygons adjacent to the Thiessen polygon; then merging the adjacent Thiessen polygons in the Thiessen polygons adjacent to the Thiessen polygon into the first merged polygon, and then perform S4 processing. If there is a non-adjacent and isolated Thiessen polygon among the queried adjacent Thiessen polygons, performing S5 processing on the non-adjacent and isolated Thiessen polygon correspondingly;

S4. Based on the first merged polygon, querying the unprocessed Thiessen polygons adjacent to the first merged polygon, and then merging the adjacent unprocessed Thiessen polygons in the unprocessed Thiessen polygons adjacent to the first merged polygon into the second merged polygon. If there is a non-adjacent and isolated unprocessed Thiessen polygon in the adjacent unprocessed Thiessen polygons, performing S5 processing on the non-adjacent and isolated Thiessen polygon correspondingly, until all Thiessen polygons are processed, including the Thiessen polygon where the end node of the must-pass nodes is located.

S5. If there is a non-adjacent isolated Thiessen polygon in the adjacent Thiessen polygons of the Thiessen polygon where the start node of the must-pass nodes is located, or in the adjacent unprocessed Thiessen polygons of a certain merged polygon, merging the isolated Thiessen polygon with a certain merged polygon with adjacent common edges, so as to ensure that there are only two adjacent merged polygons in each merged polygon, except the Thiessen polygon where the start node of the must-pass nodes is located and the Thiessen polygon where the end node of the must-pass nodes is located;

S6. The Denaulay triangle is constructed by every must-pass node, and the edge lines in Denaulay triangle whose two vertices are not in the same merged polygon are deleted;

S7. If the node degree of the remaining edge lines in the merged polygon is not greater than or equal to three, then proceed to S8, otherwise selecting the shorter edge line according to the principle of closing both sides of the graph;

S8. Connecting the edge lines of each merged polygon end-to-end, and the shortest connection line is the result.

In S8, when the edge lines of each merged polygon are connected end-to-end, if the lines are self-intersecting, the merged polygons where the self-intersecting lines are located will be merged again, and S6 to S8 will be processed again. That is, when the edge lines of each merged polygon are connected end-to-end, if there is intersection, the two merged polygons where the intersection occurs will be merged, and then S6 to S8 will be processed again to form a non-intersect line.

In S7, the steps to select the shorter edge line according to the principle of closing both sides of the graph are as follows:

S71. If there is a triangle, then removing the longest edge line. After removing the longest edge line, if the graph is still closed, the longest edge line in the closed graph will be removed again;

S72. If there is no triangle, selecting the Denaulay triangle around the node with node degree greater than three, and return to S71 again for processing to ensure that there is no node with the node degree greater than or equal to three. So as to ensure that the necessary nodes of merged polygons must be connected in turn to form a non-intersect line.

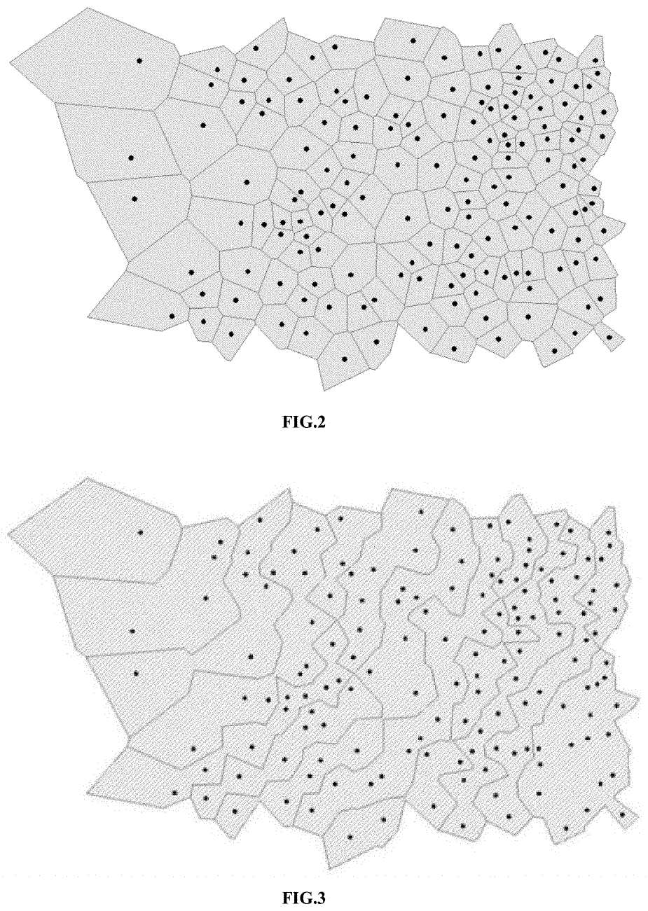

In this embodiment, in FIG. 2 to FIG. 7, the point at upper left corner is the start node of the must-pass nodes, and the farthest point at the lower right corner is the end node of the must-pass nodes.

### Embodiment 2

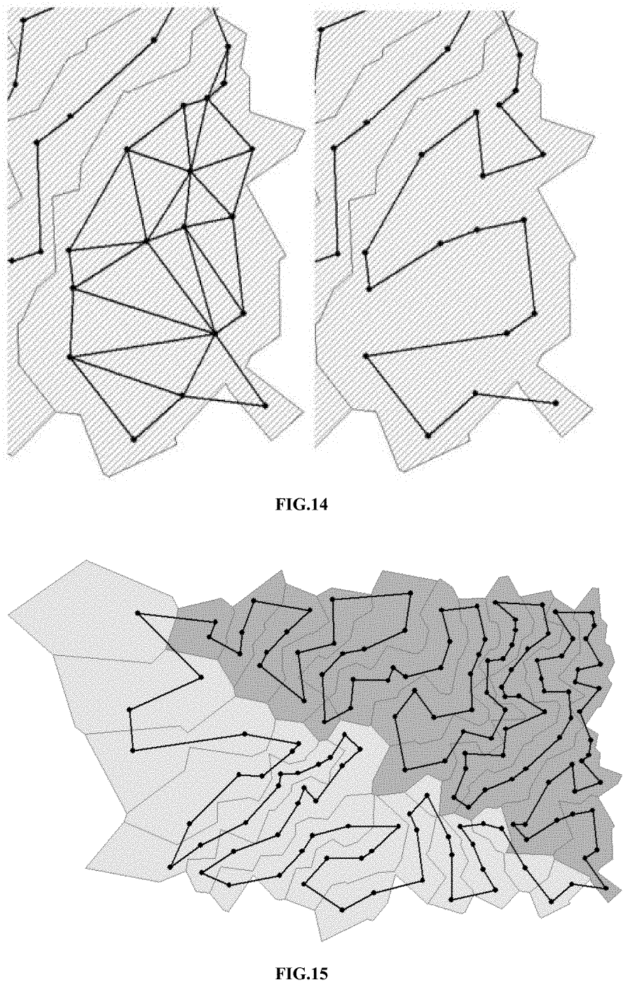

As shown in FIG. 8 to FIG. 15, the difference between this embodiment and embodiment 1 is that in S2, if the start node of the must-pass nodes and the end node of the must-pass nodes as the same must-pass node, this return type is taken as the return mode. All the must-pass nodes are divided into two parts by the boundary between the must-pass node and the must-pass node with the farthest distance to the must-pass node, and then S3 processing is performed on the two parts respectively. In this embodiment, the upper left corner of FIG. 8 to FIG. 15 is the start node of the must-pass nodes and the end node of the must-pass nodes. The processing process is to divide all the must-pass nodes into two parts by the connection line between the start node of the must-pass nodes and the must-pass node farthest from the start node of the must-pass nodes. Perform the processing of embodiment 1 on the two parts respectively to form two lines, and connect the corresponding ends of the two lines to form a closed loop as the result, which can effectively reduce the difficulty, cost and time of processing, and improve search efficiency and stability.

The above are only the preferred embodiments of the present disclosure. It should be understood that the present disclosure is not limited to the embodiments disclosed herein, and should not be regarded as the exclusion of other embodiments, but can be used in various other combinations, modifications and environments within the scope of the present disclosure, modifications can be made through the above teachings or technology or knowledge in related fields. The modifications and changes made by those skilled in the art without departing from the spirit and scope of the present disclosure should fall within the protection scope of the appended claims of the present disclosure.

What is claimed is:

1. A method for searching for the shortest path of must-pass nodes, comprising:
S1. acquiring must-pass nodes and constructing Thiessen polygons according to the must-pass nodes;
S2. determining whether a start node of the must-pass nodes and an end node of the must-pass nodes are the same must-pass node, if not, performing S3 processing directly;
S3. starting from a Thiessen polygon where the start node of the must-pass nodes is located, querying Thiessen polygons adjacent to the Thiessen polygon; then merging the adjacent Thiessen polygons in the Thiessen polygons adjacent to the Thiessen polygon in sequence into the first merged polygon, and then performing S4 processing; if there is a non-adjacent and isolated Thiessen polygon among the queried adjacent Thiessen polygons, performing S5 processing on the non-adjacent and isolated Thiessen polygon correspondingly;
S4. querying unprocessed Thiessen polygons adjacent to the first merged polygon based on the first merged polygon, and then merging adjacent unprocessed Thiessen polygons in the unprocessed Thiessen polygons adjacent to the first merged polygon in sequence into the second merged polygon; if there is a non-adjacent and isolated unprocessed Thiessen polygon in the adjacent unprocessed Thiessen polygons, performing S5 processing on the non-adjacent and isolated Thiessen polygon correspondingly, until all Thiessen polygons are processed;
S5. if there is a non-adjacent isolated Thiessen polygon in the Thiessen polygons adjacent to the Thiessen polygon where the start node of the must-pass nodes is located, or in the adjacent unprocessed Thiessen polygons of a certain merged polygon, merging the isolated Thiessen polygon with a certain merged polygon with an adjacent common edge, so as to ensure that there are only two adjacent merged polygons in each merged polygon, except the Thiessen polygon where the start node of the must-pass nodes is located and the Thiessen polygon where the end node of the must-pass nodes is located;
S6. establishing the Denaulay triangle by every must-pass node, and deleting edge lines of two vertices in Denaulay triangle that are not in the same merged polygon;
S7. if a node degree of remaining edge lines in the merged polygon is not greater than or equal to three, then performing S8, otherwise selecting the shorter edge line according to a principle of closing both sides of graph;
S8. connecting the edge lines of each merged polygon end-to-end, and the shortest connection line is a result.

2. The method for searching for the shortest path of must-pass nodes according to claim 1, wherein in S2, if the start node of the must-pass nodes and the end node of the must-pass nodes as the same must-pass node, this return type is taken as a return mode, all the must-pass nodes are divided into two parts by a boundary line between the must-pass node and a must-pass node with the farthest distance to the must-pass node, and then performing S3 processing on the two parts respectively.

3. The method for searching for the shortest path of must-pass nodes according to claim 1, wherein in S8, when the edge lines of each merged polygon are connected end-to-end, if the edge lines are self-intersecting, the merged polygons where the self-intersecting lines are located is merged again, and then performing S6 to S8 again.

4. The method for searching for the shortest path of must-pass nodes according to claim 1, wherein the steps of selecting shorter edge line according to the principle of closing both sides of the graph in S7 are as follows:
S71. if there is a triangle, then removing the longest edge line; after removing the longest edge line, if the graph is still closed, removing the longest edge line in the closed graph again;
S72. if there is no triangle, selecting the Denaulay triangle around a must-pass node with a node degree greater than three, and returning to S71 again for processing to ensure that there is no must-pass node with the node degree greater than or equal to three.

5. The shortest path search method of must-pass nodes according to claim 1, wherein the search method is used for plane solution.
